(19) United States
(12) Patent Application Publication
(10) Pub. No.: US 2005/0235443 A1
(43) Pub. Date: Oct. 27, 2005

(54) Vehicle surface conditioning apparatus

(76) Inventors: Daniel J. Mathys, Pulaski, WI (US); Kenneth J. Dollhopf, Green Bay, WI (US); John W. Plemel, Green Bay, WI (US); Rodney J. Peer, Green Bay, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/832,026

(22) Filed: Apr. 26, 2004

(51) Int. Cl. B60S 3/04

(52) U.S. Cl. 15/97.3

(57) ABSTRACT

A method and apparatus for conditioning the surface of a motor vehicle that includes multiple wash strips that both move along a circular wash path and rotate relative to the vehicle path. The apparatus includes an overhead wash strip mounting disk having a plurality of individual wash strips that extend downward toward the vehicle. The overhead mounting disk rotates relative to an orbital carriage that is supported by an overhead support frame. The orbital carriage is movable along a wash path spaced from a center axis. During operation of the apparatus, the entire orbital carriage moves along a first motion path while the mounting disk rotates along a second motion path to enhance the conditioning of the vehicle.

### FIELD OF THE INVENTION

The present invention generally relates to a method and apparatus for conditioning the outer surfaces of a motor vehicle. More specifically, the present invention relates to a method and apparatus for enhancing the conditioning of a motor vehicle to more effectively contact the surfaces of the vehicle as the vehicle passes beneath the apparatus.

### BACKGROUND OF THE INVENTION

In most automatic motor vehicle washing facilities, a motor vehicle is moved through a tunnel car wash by a conveyor system. As the vehicle is moved through the wash process, the vehicle is subjected to different wash operations to remove dirt from the vehicle.

In many automatic vehicle washing facilities, strips of material, such as felt or heavy cloth, contact the outer surfaces of the car as the car is moved through the wash process. In many systems, these wash strips oscillate along a path either parallel or perpendicular to the path of the vehicle through the wash system. Although the prior art systems have proven relatively effective in washing a vehicle in a tunnel car wash system, the single direction movement of the wash strips require multiple machines operating in transverse directions to completely cover the vehicle.

As an alternative to wash strips that oscillate in a direction either parallel or perpendicular to the path of the vehicle, wash systems have been developed that rotate wash strips about a fixed axis such that the wash strips move across the outer surface of the vehicle as the vehicle passes beneath the apparatus. Once again, the rotating movement of the wash strips relative to the vehicle results in the wash strips moving in a single direction relative to the vehicle surface. As can be appreciated above, each of the systems has a distinct disadvantage in that the systems are not optimized to remove dirt from the vehicle as the vehicle moves along the vehicle path.

Once the vehicle has been cleaned in an automatic vehicle washing facility, different types of apparatus have been used to polish the vehicle. Like the systems used to remove dirt and debris from the vehicle, many of the systems used to polish the vehicle include either rotating or oscillating wash strips that move in a single direction across the surface of the motor vehicle. It is well known from the field of hand polishing that an orbital movement of a polishing rag with a wax or polishing foam results in a higher quality gloss and shine on the motor vehicle. Thus, it is desirable for a polishing apparatus used in an automatic vehicle washing facility to move the individual wash strips in an orbital motion to result in the highest quality shine on the surface of the motor vehicle.

During the wash process in a conventional tunnel car wash system, the front windshield and both side windshields are at times simultaneously covered by the wash strips as the vehicle moves through the washing facility. In such systems, a customer who is claustrophobic can feel trapped in the motor vehicle. As a result of this feeling, many customers avoid using the tunnel car wash system and instead utilize other types of automatic vehicle washing systems. Therefore, a need exists for a tunnel car wash system that provides an open, airy feeling during the wash process while utilizing the effective properties of rotating wash strips to remove dirt and debris from the motor vehicle.

### SUMMARY OF THE INVENTION

The present invention is a method and apparatus for conditioning the surface of a motor vehicle as the motor vehicle passes beneath the apparatus along a vehicle path. The apparatus of the present invention is primarily designed for use in a car wash in which a vehicle is either driven along a vehicle path or moved by a driven conveyor assembly. The vehicle conditioning apparatus is one stage in the vehicle washing and polishing sequence and works in cooperation with other operating components to either wash or polish the motor vehicle during the wash process.

The vehicle conditioning apparatus includes a stationary support frame that extends across the vehicle path. Specifically, the stationary support frame is positioned above the vehicle path and is supported by a series of mounting posts that are secured to the floor of the wash facility. The support frame allows the vehicle to pass beneath the support frame as the vehicle is moved along the vehicle path.

The vehicle conditioning apparatus includes an orbital carriage that is suspended beneath the support frame by a plurality of support rods. The orbital carriage maintains its general orientation relative to the vehicle path as the orbital carriage moves relative to the support frame along a circular first motion path. As the carriage orbits along the first motion path, the entire orbital carriage at times moves in the same direction as the vehicle while at other times moves in an opposite direction relative to the vehicle movement.

The orbital carriage is coupled to a carriage drive motor that is mounted to the support frame. The carriage drive motor is coupled to a first end of a drive arm such that the drive arm rotates about the center axis of the carriage drive motor along with the rotation of the drive motor. The second end of the drive arm is coupled to the orbital carriage. The second end of the drive arm is spaced from the first end such that the second end rotates about the first motion path that is spaced from the center axis of the carriage drive motor.

As the carriage drive motor operates, the drive arm is rotated such that the second end of the drive arm follows the first motion path. Since the second end of the drive arm is coupled to the orbital carriage, the orbital carriage maintains its orientation and moves relative to the support frame such that the orbital carriage generally follows the first motion path. Since the orbital carriage is suspended beneath the stationary support frame by the plurality of support rods, the orbital carriage is able to move relative to the support frame due to the pivoting movement of each of the support rods. The carriage drive motor operates to move the orbital carriage in a first direction to define the first motion path.

The vehicle conditioning apparatus further includes a wash strip mounting disk that is supported beneath the orbital carriage. The wash strip mounting disk is a circular member that includes a plurality of individual wash strips mounted to its lower surface and evenly spaced around the outer circumference of the mounting disk. Each of the wash strips extends below the mounting disk a distance to contact the vehicle as the vehicle passes beneath the vehicle conditioning apparatus. The individual wash strips are spaced along the outer circumference of the mounting disk to provide consistent cleaning as the vehicle passes beneath the vehicle conditioning apparatus.

The mounting disk is rotatably supported by a drive shaft that extends through the orbital carriage and is driven by a mounting disk drive motor. The mounting disk drive motor is mounted to the orbital carriage such that both the wash strip mounting disk and the mounting disk drive motor are movable along with the orbital carriage. The mounting disk drive motor is coupled to the mounting disk such that the mounting disk drive motor is operable to rotate the mounting disk relative to the orbital carriage to define a second motion path. The rotation of the mounting disk relative to the orbital carriage is independent of the movement of the orbital carriage relative to the stationary support frame.

The wash strip mounting disk is supported in a generally horizontal plane that is spaced above the vehicle path. The wash strip mounting disk is rotatable in a second direction relative to the orbital carriage. In the preferred embodiment of the invention, the second direction of rotation of the mounting disk is in a direction opposite to the orbiting movement of the orbital carriage in the first direction to define the first motion path. Thus, the orbital carriage and the mounting disk are independently movable in opposite directions.

During operation of the vehicle conditioning apparatus of the present invention, each of the wash strips is in continuous motion along the surface of the motor vehicle due to the two different motions imparted by the vehicle conditioning apparatus. Specifically, the orbital movement of the orbital carriage in the first direction along the first motion path causes each of the wash strips to follow a generally circular wash path along the surface of the motor vehicle. At the same time, the wash strip mounting disk is rotating in the second, opposite direction relative to the motor vehicle. As a result, each of the wash strips is in constant motion along the surface of the motor vehicle. Specifically, each of the wash strips follows an orbital wash path while the wash strip is moved in the second direction as a result of the rotation of the mounting disk. This constant movement of each of the wash strips enhances the cleaning and polishing ability of each wash strip.

The mounting disk of the vehicle conditioning apparatus preferably has a width that is slightly less than the width of a typical motor vehicle. The width of the mounting disk allows the vehicle conditioning apparatus of the present invention to primarily contact the center section of a vehicle, including the hood, front windshield, roof and back windshield of the vehicle. Preferably, the vehicle conditioning apparatus does not cover the side windows of the vehicle, thus creating a more open and less confining washing environment.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a front perspective view illustrating a motor vehicle approaching the vehicle surface conditioning apparatus of the present invention;

FIG. 2 is a back view behind the motor vehicle as the motor vehicle approaches the vehicle conditioning apparatus;

FIG. 3 is a top view of the vehicle conditioning apparatus of the present invention;

FIG. 4 is a view taken along line 4-4 of FIG. 2 illustrating the wash strip mounting disk and orbital platform of the present invention;

FIG. 5 is a top view of the vehicle conditioning apparatus with the support tray removed to illustrate the movement of the wash strip mounting disk and the orbital carriage;

FIG. 6 is a perspective view of the orbital carriage and wash strip mounting disk with portions of the vehicle conditioning apparatus removed for illustrative purposes;

FIG. 7 is a magnified view of the driving connection between the mounting disk drive motor and the mounting disk;

FIG. 8 is a magnified view taken along line 8-8 of FIG. 4 illustrating the attachment of the individual wash strips to the wash strip mounting disk; and

FIGS. 9-12 are overhead illustrations showing the movement of the orbital carriage relative to the stationary support frame to define the wash path.

### DETAILED DESCRIPTION OF PREFERRED EMBODIMENTS

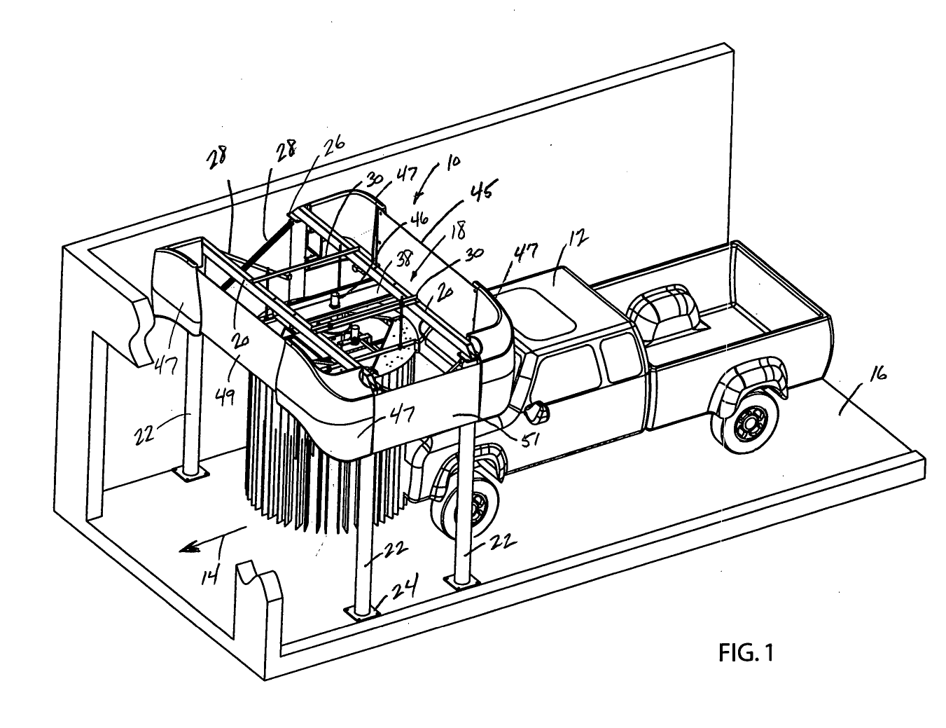

Referring first to FIG. 1, thereshown is the vehicle surface conditioning apparatus 10 of the present invention. The vehicle conditioning apparatus is isolated in FIG. 1 from the remaining components of a typical tunnel car wash system in which a vehicle 12 is moved along a vehicle path 14 through a series of operating components that remove dirt and debris from the vehicle 12 during the wash process. Although the vehicle conditioning apparatus 10 of the present invention will be described as being particularly desirable in polishing the painted surfaces of a motor vehicle, it should be understood that the vehicle conditioning apparatus is also effective in removing dirt and debris from the vehicle during the wash process. Additionally, the vehicle conditioning apparatus 10 could be used in drying the surfaces of a vehicle. When the vehicle conditioning apparatus 10 of the present invention used to remove dirt and debris from the vehicle, a detergent is applied to the vehicle prior to the vehicle passing beneath the vehicle conditioning apparatus.

Typically, a conveyor system (not shown) is mounted in the floor 16 to move the vehicle 12 along the vehicle path 14 through various operating steps within the tunnel car wash. Although a conveyor is disclosed as being one method of moving the vehicle relative to the vehicle conditioning apparatus, it is contemplated that the vehicle 12 could be either driven through the vehicle conditioning apparatus 10 or the vehicle could be stationary and the vehicle conditioning apparatus 10 move along the length of the vehicle. In a system in which the vehicle conditioning apparatus 10 moves relative to the stationary vehicle, the operating components of the vehicle conditioning apparatus could be mounted either on elevated support rails or could be supported and movable along a pair of floor mounted rails by a portal-type moving gantry system. The additional operating components within the tunnel car wash are not shown or described in the present application since these components are well known and can vary depending upon the configuration of the vehicle wash system.

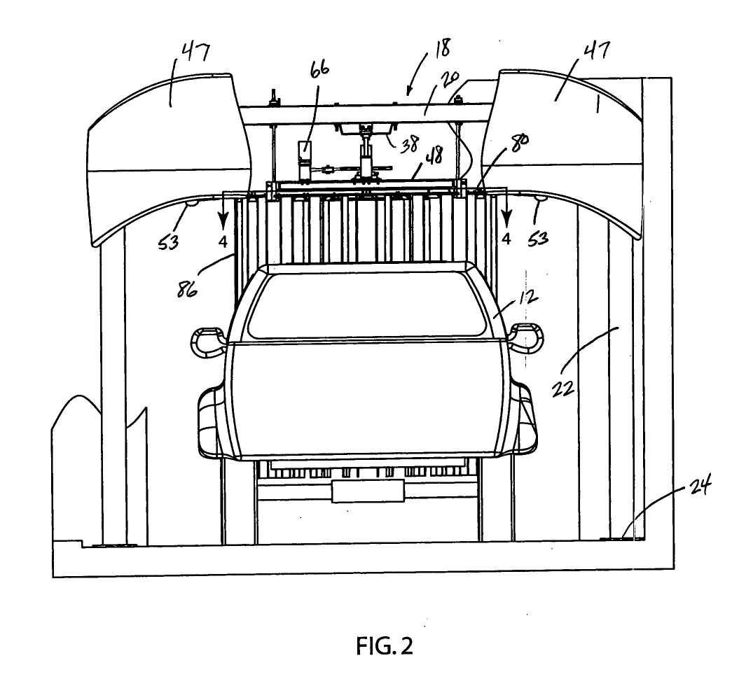

As illustrated in FIGS. 1 and 2, the vehicle conditioning apparatus 10 includes an overhead support frame 18 that extends transverse to the vehicle path 14. The support frame 18 includes a pair of cross beams 20 that are mounted between four spaced mounting posts 22. The mounting posts 22 are each securely attached to the floor 16 by a generally horizontal base 24. The base 24 provides secure support for each of the mounting posts to the floor 16. Alternatively, each of the cross beams 20 could be mounted to each of the walls of the wash bay such that the support frame is suspended over the vehicle 12.

The cross beams 20 are each securely joined to a top end 26 of the mounting posts 22 and the mounting posts 22 are joined by a pair of stabilizing beams 28 that provide structural stability for the entire upper support frame 18 relative to the mounting posts 22. In the embodiment of the invention illustrated, both the cross beams 20 and the stabilizing beams 28 are formed from a durable metal material that provides the required strength and structural rigidity for the support frame 18.

Referring now to FIG. 1, the support frame 18 includes a pair of carriage support braces 30 that each extend between the pair of spaced cross beams 20. As illustrated in FIG. 6, each of the carriage support braces 30 includes a horizontal leg 32 and a vertical leg 34. The horizontal leg 32 is securely attached to each of the cross beams 20 by a pair of connectors 36.

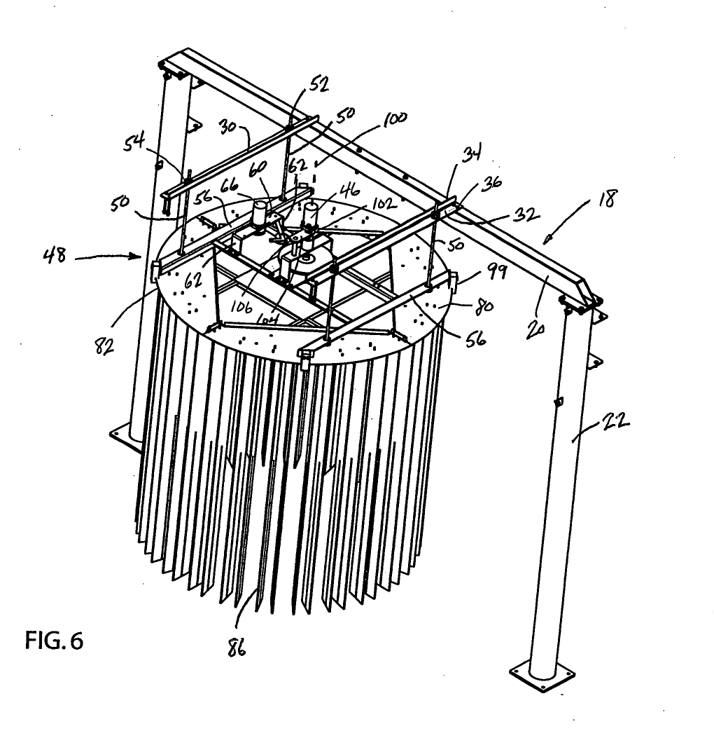

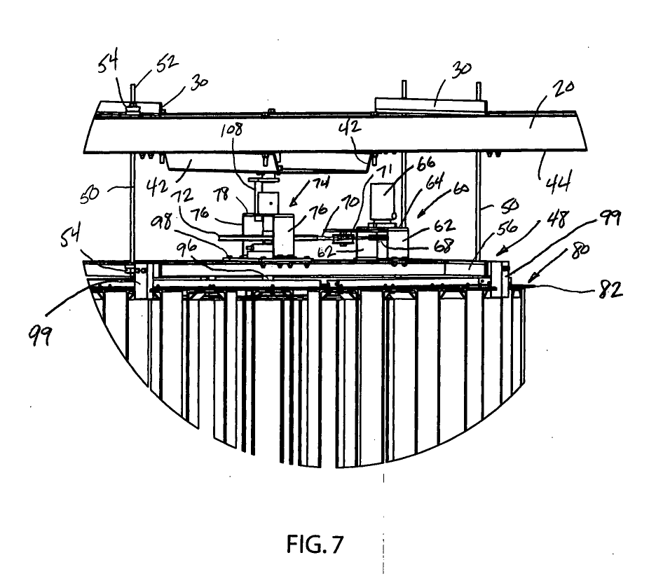

Referring back to FIG. 1, the support frame 18 further includes a support tray 38. As can be seen in FIG. 7, the support tray 38 includes a generally horizontal bottom wall 40 and a pair of upwardly angled sidewalls 42. Each of the sidewalls 42 is connected to a bottom surface 44 of each of the spaced cross beams 20. As illustrated in FIG. 1, the support tray 38 extends between the cross beams 20 and provides a mounting platform for a carriage drive motor 46 such that the carriage drive motor 46 is stationary mounted relative to the support frame 18.

The vehicle surface conditioning apparatus 10 includes a decorative front panel 45 that is connected between a pair of decorative corner sections 47. The front panel 45 and the corner sections 47 provide a more visually pleasing appearance for the vehicle surface conditioning apparatus 10 of the present invention. Additionally, the decorative front panel 45 obstructs the moving components of the vehicle surface conditioning apparatus 10 such that the operator of the motor vehicle 12 only sees the movement of the individual wash strips as the vehicle begins to pass beneath the surface conditioning apparatus 10. The apparatus includes a second pair of decorative corner sections 47 that support a similar back panel 49 and a pair of side panels 51.

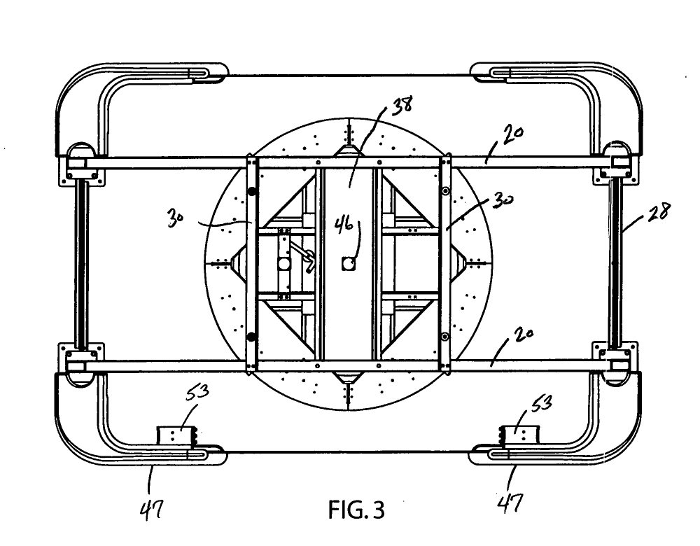

As best illustrated in FIGS. 2 and 3, the vehicle surface conditioning apparatus 10 includes a pair of spray nozzles 53 each mounted to one of the front corner sections 47. The spray nozzles 53 are connected to a supply of detergent or polishing foam and are operable to spray either the detergent or the polishing foam onto the surface of the vehicle 12. The detergent or polishing foam is applied to the vehicle 12 either prior to the vehicle passing beneath the wash strips of the apparatus 10 or as the vehicle begins to contact the wash strips. Each of the spray nozzles 53 is connected to a pressurized source of either detergent or polishing foam such that the detergent or polishing foam can be applied to the center section of the motor vehicle 12. Although the spray nozzles 53 are shown in the present invention as applying the detergent or polishing foam directly to the surface of the vehicle, it is contemplated by the inventors that the spray nozzles could direct the supply of detergent or polishing foam onto the wash strip. Once the detergent or polishing foam is applied to the wash strips, the wash strips would then be used to apply the detergent or polishing foam onto the vehicle.

As best illustrated in FIG. 6, the vehicle surface conditioning apparatus 10 includes a orbital carriage 48 that is suspended beneath the support frame 18 and is movable relative to the stationary support frame. The orbital carriage 48 is suspended beneath the support frame by four support rods 50. Each of the support rods 50 has a first end 52 that extends through one of the carriage support brackets 30. The first end 52 of each support rod 50 includes a pivot member 54 that allows the support rod 50 to pivot and rotate relative to the stationary carriage support bracket 30. Preferably, the pivot member 54 contained on each of the support rods 50 is formed from a durable, nylon material that resists wear as the support rod 50 rotates and pivots relative to the stationary carriage support bracket 30.

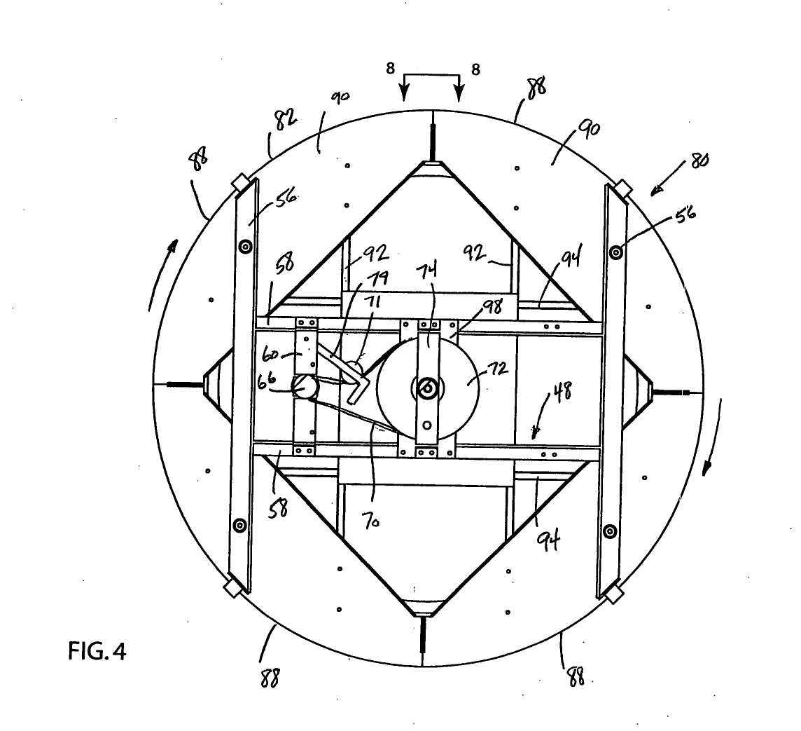

As illustrated in FIG. 6, each of the support rods 50 has a second end that is received within one of a pair of outer support rails 56 of the orbital carriage 48. As most clearly illustrated in FIG. 4, the outer support rails 56 are joined to each other by a pair of cross beams 58 that provide the required strength and rigidity for the entire orbital carriage 48. In the embodiment of the invention illustrated, both the outer support rails 56 and the cross beams 58 are L-shaped members formed from a durable metal material, such as aluminum or steel.

As illustrated in FIG. 4, the orbital carriage 48 includes a motor support bracket 60 that is mounted to and extends between the pair of cross beams 58. The motor support bracket 60 includes a pair of vertical legs 62 that support a horizontal top member 64, as best shown in FIG. 7. The motor support bracket 60 provides a secure point of attachment for a mounting disk drive motor 66. The mounting disk drive motor 66 includes a drive shaft (not shown) that extends through the top member 64 and is coupled to a drive pulley 68. The drive pulley 68 receives a drive belt 70 that passes over a tension roller 71 and is entrained around the outer circumference of a transfer pulley 72 spaced from the drive motor 66 and rotatable mounted to the orbital carriage 48. Thus, the operation of the mounting disk drive motor 66 rotates the drive pulley 68 and transfers the rotational movement to the transfer pulley 72. One advantage of this coupling between the mounting disk drive motor 66 and the transfer pulley 72 is that the drive belt 70 allows the driven connection to slip should the components coupled to the transfer pulley 72 contact a stationary or immovable object. Specifically, the drive belt 70 will slip around the outer circumference of the transfer pulley 72 while the drive motor 66 continues to rotate.

Although the mounting disk drive motor 66 and pair of pulleys 68, 72 are shown as being the preferred drive mechanism, it should be understood that the drive motor could be directly coupled to the shaft containing the transfer pulley 72. Alternatively, different types of drive mechanisms could be used to replace the mounting disk drive motor 66.

Although the mounting disk drive motor 66 and the carriage drive motor 46 are shown and described in the present invention as being separate components, it is contemplated by the inventors that a single drive element could be developed and replace the separate motors shown in the invention.

As illustrated in FIGS. 4 and 7, a transfer bracket 74 is also mounted between the pair of spaced cross beams 58. The transfer bracket 74 includes a pair of vertical legs 76 that support a top member 78. The top member 78 is spaced above the transfer pulley 72 such that the transfer pulley 72 can freely rotate beneath the transfer bracket 74. A support arm 79 is coupled to the top member 78 and supports the tension roller 71.

Referring back to FIG. 6, the vehicle conditioning apparatus 10 includes a wash strip mounting disk 80 that is supported beneath the orbital carriage 48. In the embodiment of the invention illustrated, the mounting disk 80 includes a generally circular outer circumference 82 that receives and supports a plurality of mounting strips 86 equally spaced around the outer circumference 82 to wash the motor vehicle as the motor vehicle passes beneath the vehicle surface conditioning apparatus.

Referring back to FIG. 4, in the embodiment of the invention illustrated, the wash strip mounting disk 80 is formed from four sections 88 each having a top support platform 90. The top support platforms 90 are securely connected to a first pair of cross braces 92 and a second pair of transverse cross braces 94. The cross braces 92, 94 provide the required structural stability for the mounting disk 80 while reducing the overall weight of the mounting disk. Although the four separate sections 88 are shown in the embodiment of the invention, it should be understood that the mounting disk 80 could be a single, unitary structure including the plurality of spaced mounting arms 84.

Referring now to FIG. 7, the mounting disk 80 is mounted along a horizontal plane that is spaced above the vehicle path. The mounting disk 80 is supported beneath the orbital carriage 48 and is securely connected to a drive shaft 96. The drive shaft 96 passes through a support plate 98 and is securely connected at its upper end to the transfer pulley 72. The drive shaft 96 is freely rotatable relative to the support plate 96, which in turn is fixed to the pair of spaced cross beams 58. Thus, as the transfer pulley 72 rotates, the entire mounting disk 80, coupled to the transfer pulley 72 through the drive shaft 96, also rotates. As can be understood in FIG. 7, the mounting disk 80 is rotatable through operation of the mounting disk drive motor 66. The rotation of the wash strip mounting disk 80 is separate from the movement of the orbital carriage 48. The mounting disk 80 rotates about a rotational axis that generally extends through the drive shaft 96. In the embodiment of the invention illustrated, the mounting disk drive motor 66 is operable to rotate the mounting disk 80 along a second motion path in a clockwise, second direction when viewed from above, as illustrated in FIG. 4.

As illustrated in FIGS. 6 and 7, each of the support rails of the orbital carriage 48 includes a pair of guide blocks 99 mounted to the opposite ends of the respective support rail 56. Each of the guide blocks 99 includes a slot that receives the outer circumferential edge 82 of the mounting disk 80. The guide blocks 99 help define the rotational path of the mounting disk 80 and prevent the mounting disk 80 from becoming detached should any of the wash strips 86 become entangled with a stationary object.

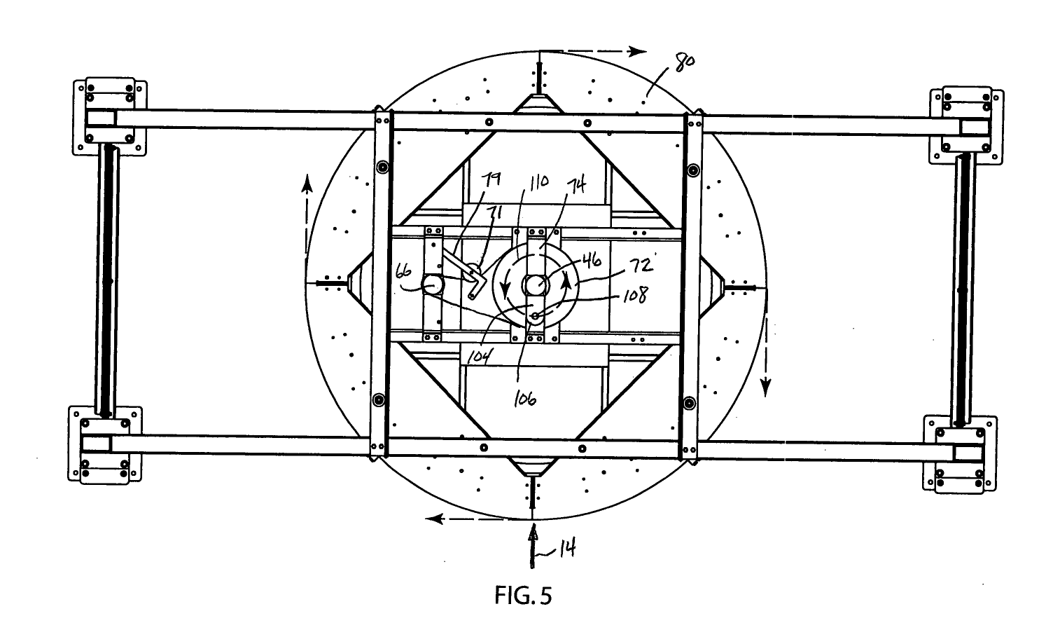

Referring now to FIGS. 5 and 6, the carriage drive motor 46 includes an internal drive shaft that rotates about a center axis as illustrated by the dashed line 100 shown in FIG. 6. The drive shaft of the carriage drive motor 46 is securely fixed to a first end 102 of a drive arm 104. The drive arm 104 extends between the first end 102 and a second end 106.

As illustrated in FIG. 5, the second end 106 of the drive arm 104 is connected to the transfer bracket 74 by a connection pin 108. The connection pin 108 is fixed to the drive arm 104 and is rotatable relative to the transfer bracket 74. As can be understood in FIG. 5, when the carriage drive motor 46 rotates, the internal drive shaft of the motor 46 causes the drive arm 104 to rotate in the counter-clockwise direction when viewed from above. As the drive arm 104 rotates, the pivot pin 108 travels along a first motion path illustrated by the dashed lines 110 in FIG. 5. As illustrated, the first motion path 110 is spaced from the center axis passing through the carriage drive motor 46 by the distance between the connection between the carriage drive motor 46 and the first end of the drive arm 104 and the connection between the second end 106 of the drive arm 104 and the transfer bracket 74. Thus, when the carriage drive motor 46 is operated, the entire orbital carriage 48 is moved along the first motion path 110, illustrated in FIG. 5. In the embodiment of the invention illustrated in FIG. 5, the orbital carriage moves in a first, counter-clockwise direction while the mounting disk 80 is separately and independently rotatable in a second, clockwise direction, as illustrated. During testing of the vehicle conditioning apparatus of the present invention, the opposite rotational directions for the mounting disk 80 and the orbital platform was found to be the most effective in both polishing and washing a motor vehicle moving beneath the apparatus along the vehicle path.

Although in the preferred embodiment of the invention the mounting disk 80 and the orbital carriage 48 are rotated in opposite directions, it is contemplated by the inventors that the mounting disk 80 and orbital carriage 48 could be rotatable in the same direction. Further, the speed of rotation of both the mounting disk 80 and the orbital motion of the orbital carriage 48 can be varied depending upon the specific application for the vehicle surface conditioning apparatus 10 of the present invention. The speed of rotation of both the mounting disk 80 and the orbital speed of the orbital carriage 48 depend upon the speed of movement of the apparatus 10 relative to the motor vehicle 12.

As can be understood by the description above, when a motor vehicle is positioned beneath the vehicle conditioning apparatus 10 of the present invention, each of the individual wash strips 86 contacts the surface of the vehicle. When the wash strip is in contact with the surface of the vehicle, the movement of the orbital carriage 48 causes each of the individual wash strips to move along an orbital wash path in the first direction of rotation of the orbital carriage 48. This movement of each of the wash strips causes the wash strip to move along the surface of the vehicle in a generally circular wash path.

At the same time each wash strip is moving along the circular wash path in the first direction, the mounting disk 80 is rotating in the second direction. Thus, each of the wash strips is not only moving in the first direction along the circular wash path but is also being rotated, along with the rotation of the mounting disk, in the second clockwise direction. The combined, two-part movement of each of the washing strips during operation of the vehicle surface conditioning apparatus 10 results in each of the wash strips being in continuous motion along the surface of the motor vehicle. Further, the two-part motion of the washing strips results in a movement that more closely corresponds to the optimal, circular movement of a polishing rag during hand polishing of a vehicle.

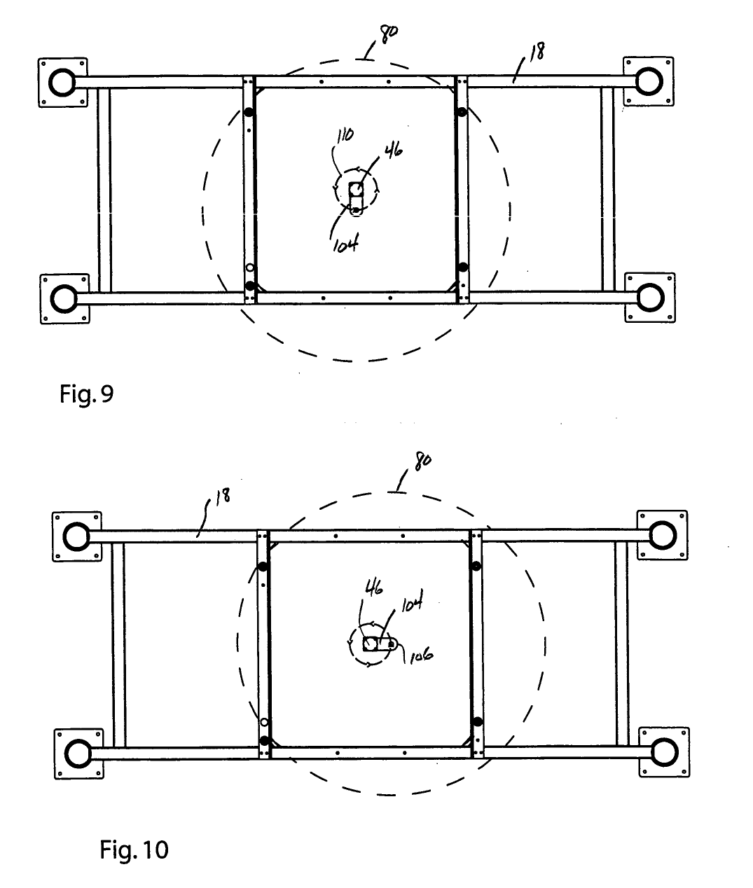

Referring now to FIG. 9, the position of the mounting disk 80 is shown when the drive arm 104 is in the six o'clock position. As illustrated, the mounting disk 80 is shifted in the direction of vehicle travel along the vehicle path relative to the stationary support frame 18.

As the carriage drive motor 46 rotates, the drive arm 104 rotates in a counter-clockwise direction to the three o'clock position illustrated in FIG. 10. Since the second end 106 of the drive arm is coupled to the orbital carriage, the entire orbital carriage and mounting disk 80 is shifted forward and to the right as compared to the position shown in FIG. 9.

Referring back to FIG. 6, the orbital carriage 48 is supported below the support frame 18 by the four support rods 50. As described previously, each of the support rods 50 is pivotally mounted to one of the carriage support brackets 30 at a first end and to one of the outer support rails 56 of the orbital carriage at its opposite, second end. Thus, as the carriage drive motor 46 rotates the drive arm 104, the four support rods 50 allow the entire orbital carriage to shift to the left and forward, as illustrated in FIG. 10. Thus, as can be understood in FIG. 6, during rotation of the drive arm 104, the orbital carriage 48 orbits about a center axis via the support rods 50 and does not rotate relative to the carriage drive motor 46.

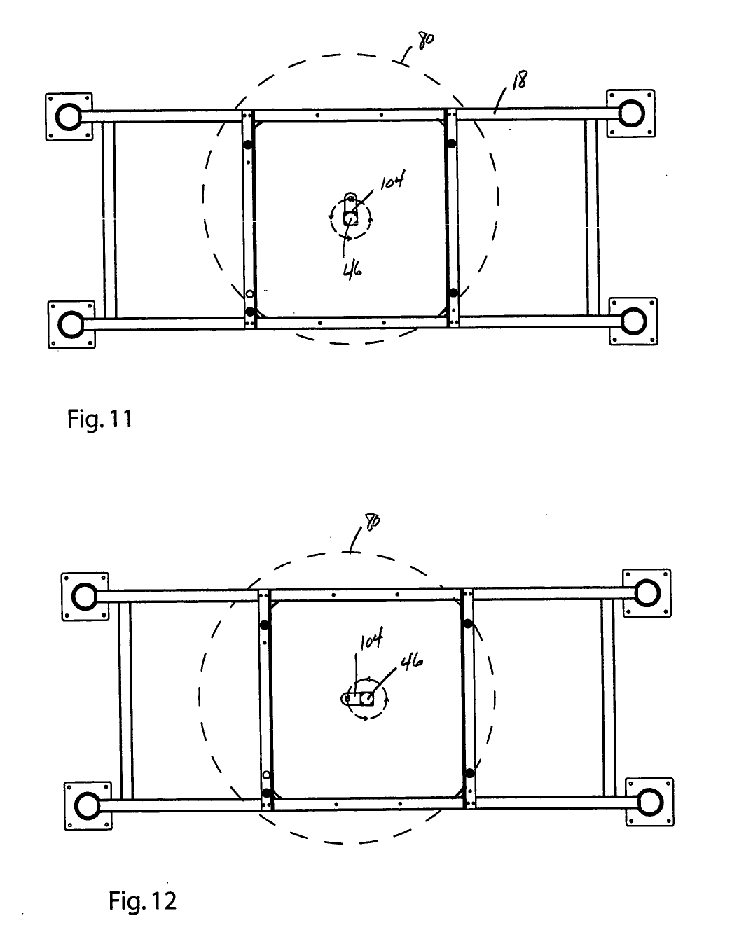

Referring now to FIG. 11, as the carriage drive motor 46 continues to operate, the drive arm 104 rotates to the twelve o'clock position, as illustrated. In the twelve o'clock position, the mounting disk 80 is moved further forward along the vehicle path and further to the left as compared to the position shown in FIG. 10. Thus, the counter-clockwise rotation of the drive arm results in the movement of the mounting disk 80 along the vehicle path in a direction opposite to the movement of the vehicle.

Referring now to FIG. 12, as the carriage drive motor 46 continues to operate, the drive arm 104 rotates into the nine o'clock position illustrated in FIG. 12. As can be seen in the comparison of FIGS. 11 and 12, as the drive arm 104 continues to rotate, the mounting disk 80 moves further to the left and moves in the same direction as the vehicle along the vehicle wash path. The movement of the mounting disk in the same direction as the vehicle along the vehicle path allows the individual wash strips hanging from the mounting disk to move into contact with a back surface of the vehicle. The movement of the entire wash platform, including the mounting disk 80, in the same direction as the vehicle allows the individual wash strips to contact a back surface of the vehicle to improve the washing of the back surface of the vehicle.

As discussed previously, the combined rotational movement of the mounting disk 80 and the orbiting movement of the entire orbital carriage 48 causes each of the wash strips to be in continuous movement along the surface of the vehicle positioned beneath the vehicle conditioning apparatus 10. The continuous movement of each of the wash strips allows each of the wash strips to more effectively and efficiently move along the surface of the vehicle. This movement of each of the wash strips results in increased performance and better polishing and cleaning as compared to prior art systems.

As can be understood in FIGS. 9-12, the entire orbital carriage, including the wash strip mounting disk 80 suspended beneath the orbital carriage, moves along the first motion path 110. At the same time the orbital carriage and mounting disk 80 are moving counter clockwise along the first motion path, the mounting disk 80 is rotated in an opposite, clockwise direction. The rotation of the mounting disk 80 is separate from the movement of the orbital carriage along the first motion path 110. The opposite directions of the rotation of the first motion path 110 and the rotation of the mounting disk 80 aid in effectively cleaning a vehicle passing beneath the vehicle conditioning apparatus of the present invention.

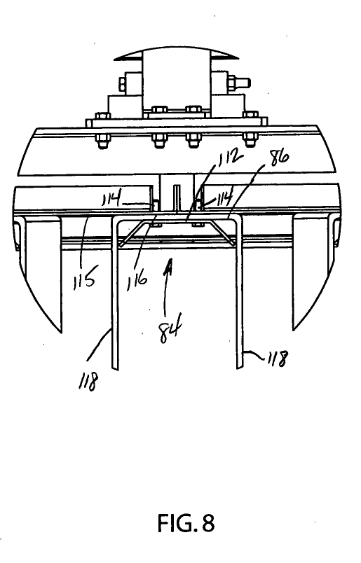

Referring now to FIG. 8, thereshown is the mounting arrangement 84 that is used to support and secure a wash strip 86. As illustrated, the wash strip 86 extends over a top surface 112 of a mounting bracket. A pair of retainers 114 are used to hold the continuous wash strip in place between the mounting bracket and the bottom surface 115 of the mounting disk. In the preferred embodiment of the invention, the wash strip 86 is a single piece of material that includes a center section 116 that passes over the mounting bracket and is joined to a pair of side strips 118. The side strips 118 contact the vehicle to provide the required cleaning during the wash process.

As illustrated in FIG. 8, each of the wash strips 86 is oriented such that each of the side strips 118 extend generally along the radius of the mounting disk to which they are mounted. This orientation of each wash strip 86 has been found to provide the most desired cleaning and polishing of the surface of the vehicle beneath the vehicle surface conditioning apparatus of the present invention. However, it is contemplated that the orientation of each of the wash strips 86 relative to the mounting disk could be varied depending upon the particular application for the apparatus of the present invention.

In the embodiment of the invention shown, the wash strip 86 is formed from a neoprene material sold under the commercial name Neoglide® and is manufactured by Kirikian Industries. The neoprene material used for the wash strips 86 has the advantage of decreasing the weight of each wash strip as compared to conventional wash strip material, such as heavy cloth or felt. Additionally, the neoprene wash strips 86 have less weight and thus make less noise when the strips initially contact a vehicle, which is seen by a consumer as being more vehicle friendly. Although the preferred embodiment of the invention is shown and described as including neoprene wash strips 86, it should be understood that the invention could include conventional wash strips formed from cloth or felt material while operating within the scope of the present invention.

Referring back to FIG. 2, the mounting disk 80 in the preferred embodiment of the invention has an outer diameter that is slightly less than the width of the vehicle 12. Thus, as the vehicle 12 passes beneath the mounting disk 80, the individual wash strips 86 cover only the center of the vehicle without completely obstructing the side windows. Further, the spacing between the individual wash strips 86 allows the vehicle conditioning apparatus to have a more open appearance which aids in comforting claustrophobic car wash customers.

Once the vehicle has passed beneath the vehicle surface conditioning apparatus of the present invention, the pair of conventional side brush members (not shown) are used to polish and clean the sides of the vehicle 12. Thus, the vehicle surface conditioning apparatus of the present invention is intended to wash only the center portion of the vehicle, including the hood, front windshield, roof and rear windshield. By separating the washing of the center section and the vehicle sides into two separate stages, it is hoped that claustrophobic customers will be presented with a more pleasing wash experience and thus be more likely to frequent the tunnel wash system including the vehicle wash and polishing apparatus of the present invention.

Although the vehicle surface conditioning apparatus of the present invention is described in the preferred embodiment of the invention as having the wash strips spaced at their furthest, a width that is generally less than the width of a conventional motor vehicle, it is contemplated by the inventors that the size of the mounting disk could be increased such that the wash strips would contact the sides of the motor vehicle as the vehicle passes beneath the surface conditioning apparatus. This type of system would provide cleaning and/or polishing to the sides of the vehicle at the same time as the center section of the vehicle is conditioned. Although it is contemplated that separate apparatus for cleaning and/or polishing the sides of the vehicle would be a more preferred embodiment, the use of an expanded width vehicle conditioning apparatus constructed in accordance with the invention may provide additional benefits in some car wash environments.

Various alternatives and embodiments are contemplated as being within the scope of the following claims particularly pointing out and distinctly claiming the subject matter regarded as the invention.

1. An apparatus for conditioning the surface of a motor vehicle that passes beneath the apparatus to define a vehicle path, comprising:
an orbital carriage movable along a first motion path relative to a support frame positioned above the motor vehicle; and
a wash strip mounting disk having a plurality of wash strips extending below the mounting disk, the mounting disk being supported in a generally horizontal plane above the vehicle path and rotatable along a second motion path relative to the orbital carriage,
wherein the orbital carriage is movable along the first motion path separate from the rotation of the mounting disk along the second motion path.

2. The apparatus of claim 1 further comprising:
a carriage drive motor operable to move the orbital carriage relative to the support frame along the first motion path; and
a mounting disk drive motor operable to rotate the mounting disk relative to the orbital carriage along the second motion path.

3. The apparatus of claim 2 further comprising a drive arm having a first end connected to the carriage drive motor and a second end coupled to the orbital carriage.

4. The apparatus of claim 3 wherein the carriage drive motor extends along a center axis that passes through the first end of the drive arm, wherein the carriage drive motor rotates the drive arm about the center axis in a first direction.

5. The apparatus of claim 4 wherein the orbital carriage is movable along the circular wash path spaced from the center axis of the carriage drive motor.

6. The apparatus of claim 1 wherein the orbital carriage is movable along the first motion path in a first direction and the wash strip mounting disk is rotatable along a second motion path relative to the orbital carriage in a second direction, wherein the first direction is opposite to the second direction.

7. The apparatus of claim 1 wherein the mounting disk is movable with the orbital carriage along the first motion path while the mounting disk rotates along the second motion path.

8. The apparatus of claim 1 wherein the wash strips are spaced from each other along an outer circumference of the mounting disk.

9. The apparatus of claim 1 wherein each of the wash strips is formed from neoprene.

10. The apparatus of claim 1 wherein the carriage drive motor causes the orbital carriage to orbit about a center axis, wherein the orbital carriage maintains a constant orientation relative to the vehicle path as the orbital carriage orbits about the center axis.

11. The apparatus of claim 10 wherein the orbital carriage is suspended beneath the support frame by a plurality of support rods, wherein each of the support rods is pivotally movable relative to the support frame and pivotally movable relative to the orbital carriage.

12. The apparatus of claim 1 wherein the mounting disk has a width less than a width of the motor vehicle.

13. The apparatus of claim 1 further comprising at least one spray nozzle operable to apply a conditioning agent to the vehicle.

14. A method of conditioning the surface of a motor vehicle comprising the steps of:
providing a plurality of wash strips supported along a mounting member, each wash strip positioned to contact the vehicle as the vehicle passes beneath the wash strips;
moving the mounting member such that the mounting member orbits about a center axis such that each of the wash strips moves along the surface of the vehicle to define a circular wash path as the mounting member orbits about the center axis; and
rotating the mounting member as the mounting member orbits about the center axis such that the circular wash path of each wash strip moves along the vehicle surface with the rotation of the mounting member.

15. The method of claim 14 wherein the mounting member is a circular mounting disk having an outer circumference.

16. The method of claim 15 wherein each of the wash strips is mounted adjacent the outer circumference of the mounting disk.

17. The method of claim 14 wherein the mounting member orbits about the center axis simultaneously with the rotation of the mounting member.

18. The method of claim 17 wherein the mounting member orbits about the center axis in a first direction and the mounting member rotates in a second direction, wherein the first direction is opposite the second direction.

19. The method of claim 14 further comprising the step of applying a detergent to the surface of the motor vehicle.

20. The method of claim 14 further comprising the step of applying a polishing foam to the surface of the motor vehicle.

21. The method of claim 20 wherein the step of applying the polishing foam includes spraying the polishing foam onto the surface of the vehicle such that the movement of the wash strips along the vehicle surface enhances the shine of the vehicle.

22. The method of claim 14 wherein the orbiting movement of the mounting disk about the center axis and the rotation of the mounting disk results in continuous movement of the wash strips along the surface of the motor vehicle.

23. A method of conditioning the surface of a motor vehicle comprising the steps of:
providing an orbital carriage suspended above a vehicle path such that the motor vehicle can pass beneath the orbital carriage along the vehicle path, the orbital carriage including a wash strip mounting disk having a plurality of wash strips extending below the mounting disk to contact the motor vehicle as the motor vehicle passes beneath the orbital carriage;
moving the orbital carriage such that the orbital carriage orbits about a center axis such that each of the wash strips moves along a circular wash path as the orbital carriage orbits about the center axis; and
rotating the mounting disk relative to the orbital carriage such that the rotating mounting disk moves the wash path of each of the plurality of wash strips relative to the vehicle,
wherein each of the wash strips simultaneously moves along the circular wash path and rotates relative to the orbital carriage.

24. The method of claim 23 wherein the orbital carriage orbits the center axis in a first direction and the mounting disk rotates relative to the orbital carriage in a second direction, wherein the second direction is opposite to the first direction.

25. The method of claim 23 wherein the orbital carriage orbits about the center axis simultaneously with the rotation of the mounting disk relative to the orbital carriage such that each of the wash strips is in continuous movement relative to the motor vehicle.

26. The method of claim 23 further comprising the step of applying a cleaning detergent to the motor vehicle.

27. The method of claim 23 further comprising the step of applying a polishing foam to the motor vehicle.

28. The method of claim 23 wherein each of the wash strips is mounted adjacent to an outer circumference of the mounting disk.

29. An apparatus for conditioning the surface of a motor vehicle that passes beneath the apparatus to define a vehicle path, comprising:
an orbital carriage that orbits about a center axis along a first motion path; and
a wash strip mounting disk having a plurality of wash strips extending below the mounting disk, the mounting disk being supported in a generally horizontal plane above the vehicle path and movable along the first motion path with the orbital carriage, the wash strip mounting disk being rotatable along a second motion path relative to the orbital carriage independent from the orbiting movement of the orbital carriage about the center axis.

30. The apparatus of claim 29 wherein each of the wash strips moves along a circular wash path as the orbital carriage orbits about the center axis.

31. The apparatus of claim 30 wherein the orbital carriage orbits along the first motion path in a first direction and the wash strip mounting disk is rotatable along the second motion path in a second direction, wherein the second direction is opposite the first direction.

32. The apparatus of claim 31 wherein the mounting disk is movable with the orbital carriage in the first direction while the mounting disk is simultaneously rotatable relative to the orbital carriage in the second direction.

33. The apparatus of claim 29 wherein the mounting disk has a width less than the width of the motor vehicle.
